(19) United States
(12) Patent Application Publication
(10) Pub. No.: US 2018/0237281 A1
(43) Pub. Date: Aug. 23, 2018

(54) EPOXY APPLICATOR NOZZLE FLUSH ADAPTOR AND METHOD

(71) Applicant: Samuel Palmer, Laguna Beach, CA (US)

(72) Inventor: Samuel Palmer, Laguna Beach, CA (US)

(21) Appl. No.: 15/817,061

(22) Filed: Nov. 17, 2017

Related U.S. Application Data
(60) Provisional application No. 62/423,956, filed on Nov. 18, 2016.

(51) Int. Cl. B67D 1/00; B01F 5/06

(52) U.S. Cl. CPC B67D 1/0044; B01F 2215/006; B01F 5/061

(57) ABSTRACT

A nozzle flush adapter includes an externally threaded coupler configured to threadably engage and secure a mixer nozzle in a fluid tight coupling together with a hose receiving coupler having an internal thread configured to engage and secure the threaded end of a conventional water hose in a fluid tight coupling. The nozzle flush adapter facilitates cleaning and reuse of normally disposable mixer nozzles exposed to two-component epoxy adhesives and the like by allowing the user to exercise a method whereby the user is able to flush water under pressure through the mixer nozzle before the material has cured.

### CROSS-REFERENCE TO RELATED APPLICATION

This application claims the benefit of and priority under 35 U.S.C. 119(e) of U.S. Provisional Patent Application No. 62/423,956 entitled EPOXY APPLICATOR NOZZLE FLUSH ADAPTER AND METHOD, filed Nov. 18, 2016 in the name of Samuel Palmer, the disclosure of which is incorporated herein by reference.

### FIELD OF THE INVENTION

This invention relates generally to applicators for two-component adhesives, epoxies, or the like, characterized by utilizing a pair of material cartridges one of which includes a supply of a primary materials such as an epoxy resin while the remaining cartridge includes a supply of material such as a catalyst or hardener. The invention relates particularly to a method and apparatus for more efficiently utilizing the dispensing nozzles employed on such applicators.

### BACKGROUND OF THE INVENTION

In many construction arts chemical compounds, such as adhesives or sealants, are comprised of a primary material, such as epoxy resin, together with a secondary material, such as a catalyst or hardener. These compounds provide great advantages and inefficiency in the assembling and joining of construction components. One such material is often referred to as an epoxy adhesive or simply as “epoxy”. Such compounds are characterized in that the components are readily stored for long periods of time without deterioration or hardening. However, once the resin and the hardener are combined, the resin hardens and sets quickly and irreversibly. To facilitate the efficient use and easy application of such two-component epoxy, practitioners in the art have developed a variety of apparatus utilized in mixing and applying the epoxy resin and catalyst material. One typical type of device is generally known in the art as an “applicator gun” or simply “gun”. While the design of such applicator guns is subject to considerable variation, generally speaking most utilize a support frame haying receiving structures into which a pair of material cartridges may be inserted. The gun typically includes a pair of movable pressure apparatus which are utilized in exerting a pressure against each of the cartridge rear portions. The typical cartridge further includes a discharge port at the forward and of the cartridge. The gun further includes a material coupler having material passages joined to the discharge ports of the two cartridges. When pressure is applied to the cartridge rear portions by operation of the applicator gun, material within the cartridges is forced to flow outwardly through the discharge ports of the cartridges. The material passages within the material coupler combine to provide a flow of material from each of the cartridges and a mixing of the components to flow a combined stream of both components. The material coupler further includes a combined material discharge port having a plurality of threads for receiving and supporting a mixture nozzle.

A mixer nozzle is threadably secured to the discharge port of the material coupler and comprises an elongated tubular nozzle structure having a material coupler, a mixer chamber and a discharge tip all in generally coaxial alignment. The mixer chamber defines a mixer passage within which an elongated mixer is disposed. The mixer typically includes a plurality of angled vanes spaced along the mixer and angled with respect to the mixer chamber axis of elongation. The mixer nozzle further includes an elongated discharge tip. The length of the discharge tip varies to suit various applications.

Once the material cartridges have been loaded into the applicator gun, the mixer nozzle is assembled to the material coupler of the gun, at which point the applicator gun is loaded and ready for use. Thereafter, the operator manipulates the applicator gun to position it upon the work piece. The material feed mechanism of the applicator gun is activated to discharge a mixture of the two component materials by applying pressure to the rear portions of each material cartridge causing material from each cartridge to flow into the material coupler and into the mixer chamber of the mixer nozzle. As material is caused to flow into and through the mixer chamber, the two component flows are mixed to form the desired material combination. Thereafter, as the operator continues to manipulate the applicator gun the mixed material is caused to flow outwardly through the discharge tip.

As mentioned above, in a typical example of the use of such apparatus in a construction environment the two material cartridges hold an epoxy resin and a catalyst or hardener. In accordance with the intended use of such epoxy materials, the combination of the epoxy resin and a suitable quantity of hardener produces a chemical reaction which “cures” the epoxy adhesive causing it to harden into a high strength bond. It is important to understand that once the epoxy resin and the hardener are combined, the chemical reaction or curing and hardening of the material proceeds directly and cannot be reversed or delayed. As a result, in the typical uses of such two-component epoxy adhesives, or the like, considerable preparation and thought must he utilized before commencing operations to avoid wasting material.

In most construction operations, practitioners endeavor to set up multiple adhesive operations and procedures prior to loading and operating the applicator gun. The objective is to make the most efficient use of the system components of the applicator gun, most particularly the mixer nozzle, which are exposed to the combined epoxy resin and the hardener in a single continuous process. Of necessity, once the applicator gun has been utilized in depositing the mixture of epoxy resin and hardener as required, termination of application procedures has here to for necessitated disposing of the mixer nozzle due to hardening and curing of the combined epoxy resin and hardener which fills the mixing chamber during operation.

In most operations which employ the high strength two-component type of epoxy adhesives and the like, the operator maintains a supply of mixer nozzles which are considered to be single use and disposable. As a result, the user operates the applicator gun as needed and following each period of operation, removes and discards the mixer nozzle. As will be appreciated, this system is particularly wasteful and inefficient when necessity requires short-term “small job” applicator use. On the one hand, the construction site operator cannot afford to have expensive labor resources unduly disrupted, or delayed, by the need to “collect” a plurality of functions requiring the application of an epoxy adhesive. On the other hand, the construction site operator may be reluctant to “waste” mixer nozzles to make small number adhesive applications. In the end, the economies of most construction site activities must be governed by the need to efficiently utilize high cost labor resources. As a result, the repeated use of adhesive applicator guns and discard of mixer nozzles following each use creates a substantial cost penalty which has-been tolerated as “unavoidable”.

There arises therefore a continuing and unresolved need in the art for an apparatus and method which provides a more cost-effective and more efficient utilization of the mixer nozzles within operations which employ two component adhesives such as epoxy adhesives or the like.

### SUMMARY OF THE INVENTION

Accordingly, it is a general object of the present invention to provide an improved apparatus and method for utilizing the mixer nozzles employed in two-component applicator guns and like apparatus. It is a more particular object of the present invention to provide an improved apparatus and method for utilizing the mixer nozzles employed in two-component applicator guns which facilitates the reuse of mixer nozzles. It is a still more particular object of the present invention to provide an improved apparatus and method for utilizing the mixer nozzles employed in two-component applicator guns that provides or cleaning and reusing mixer nozzles.

The present invention epoxy applicator nozzle flush adapter and method provides a flush adapter having an externally threaded coupler configured to threadably engage and secure a mixer nozzle in a fluid tight coupling together with a hose receiving coupler having an internal thread configured to engage and secure the threaded end of a conventional water hose in a fluid tight coupling. The nozzle flush adapter facilitates cleaning and reuse of mixer nozzles exposed to two-component epoxy adhesives and the like by allowing the user to flush water under pressure through the mixer nozzle before the material has cured.

In accordance with the present invention, there is provided combination: a mixer nozzle having a material coupler defining a plurality of internal threads, an elongated mixer chamber supporting an elongated mixer, a discharge tip extending from the mixer chamber and a mixer passage extending through the material coupler, mixer chamber and discharge tip; a nozzle flush adapter body defining a hose coupler having a plurality of internal threads supported therein, a cylindrical extension extending from the hose coupler, a threaded coupler extending from the cylindrical extension and defining a plurality of external threads and a cylindrical end extending from the cylindrical extension; and a nozzle flush adapter passage extending through the hose coupler, the cylindrical extension, the threaded coupler and the cylindrical extension, whereby the nozzle flush adapter is assembled to the end of a conventional water hose by threading the end thereof into the plurality of internal threads and thereafter joining said mixer nozzle to the nozzle flush adapter by threading the external threads into the plurality of internal threads of the material coupler of the mixer nozzle after which a flow of water from the hose flows through the nozzle flush adapter passage and the mixer nozzle to flush material from the mixer nozzle and prepare it for reuse.

When viewed from another perspective, the present invention provides a method for using and reusing a mixer nozzle utilized in the mixing and application of a two component compound comprising the steps of: providing a mixer nozzle, a pair of material cartridges, and applicator; operating the applicator to mix material flowing from the pair of cartridges and to dispense a flow of mixed material; depositing the mixed material upon a work piece; removing the mixer nozzle from the applicator; providing a nozzle flush adapter having a nozzle flush adapter body defining a hose coupler having a plurality of internal threads supported therein, a cylindrical, extension extending from the hose coupler, a threaded coupler extending from the cylindrical extension and defining a plurality of external threads and a cylindrical end extending from the cylindrical extension; assembling the mixer nozzle to the nozzle flush adapter; assembling the nozzle flush adapter to a water hose, the water hose coupled to a water supply; flowing water from the hose through the nozzle flush adapter and the mixer nozzle to flush and expel remaining two-part mixed compound from the mixer nozzle; removing the mixer nozzle from the nozzle flush adapter; and reusing mixer nozzle.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a partial perspective view of an illustrative prior art applicator gun and mixer nozzle constructed in accordance with conventional fabrication to which the present invention applies;

FIG. 2 sets forth an assembly view of the prior art applicator gun mixer nozzle shown above together with a flush adapter constructed in accordance with the present invention and an illustrative hose coupling;

FIG. 3 sets forth a section view of a conventional mixer nozzle together with the present invention flush adapter and a conventional hose coupler;

FIG. 4 sets forth a side view of an alternate embodiment of the present invention flush adapter;

FIG. 5A sets forth a section view of the flush adapter shown in FIG. 4 in an open valve configuration;

FIG. 5B sets forth a section view of the flush adapter shown in FIG. 4 in a closed valve configuration; and

FIG. 6 sets forth a block diagram of the present invention method for cleaning and reuse of mixer nozzles employing the present invention flush adapter.

### DESCRIPTION OF THE PREFERRED EMBODIMENTS

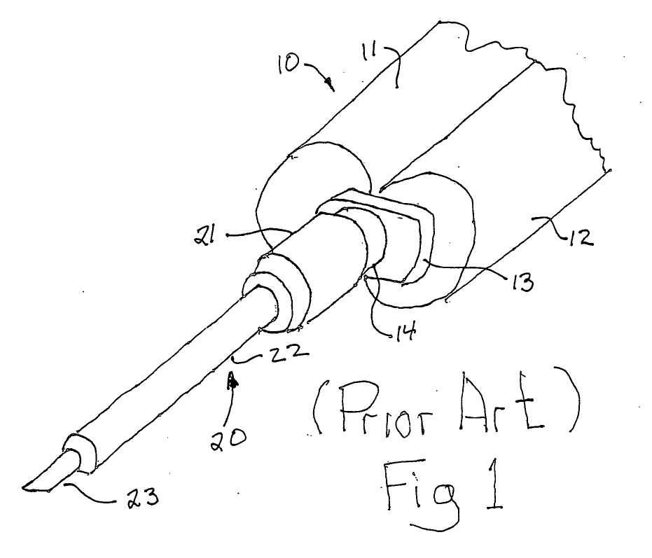

FIG. 1 sets forth a partial perspective view of an illustrative prior art applicator gun generally referenced by 10 and supporting a pair of conventional material cartridges 11 and 12. Applicator gun 10 further supports a material coupler 13 which is coupled to cartridges 11 and 12 and which further includes a forwardly extending combined material port 14. A mixer nozzle 20, constructed in accordance with conventional fabrication, includes a material coupler 21, a mixer chamber 22 and a discharge tip 23. In its preferred fabrication mixer nozzle 20 is formed as an integral structure utilizing molded plastic material or the like. Mixer coupler 21 defines an internal thread coupling which is utilized in securing mixer nozzle 22 combined material port 14 of material coupler 13.

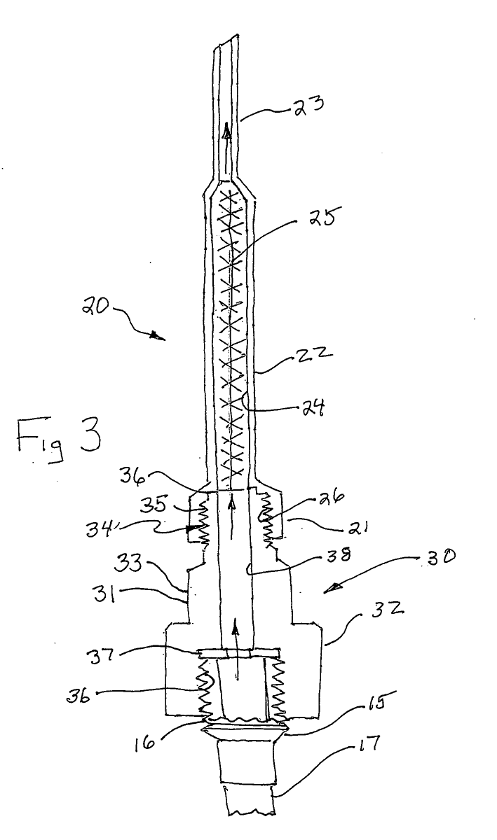

In accordance with the above described operation, applicator gun 10, having received filled cartridges 11 and 12 and having the required operational coupling thereof to material coupler 13, is prepared for use by securing mixer nozzle 22 to combined material port 14 utilizing the threaded coupling shown below in FIG. 3. Thereafter, the above described use of applicator gun 10 forces material from cartridges 11 and 12 into material coupler 13 and combined material port 14 to flow the two adhesive material components into mixer nozzle 20. The combined material flows are then forced through mixer chamber 22 which, as it is better seen in FIG. 3, defines a mixer passage 24 which supports a mixer 25. By means described below, mixer 25 within mixer chamber 22 completes the mixing of the two material component flows providing a flow of fully mixed adhesive material into discharge tip 23. The material, now fully mixed, flows outwardly from discharge tip 23 and is deposited upon the work piece.

Of importance to note in the consideration of the present invention, this use of applicator gun 10, as described, fills mixer nozzle 20 with a mixture of the two-component resin and hardener. Accordingly, once the operation of applicator gun 10 is terminated and applicator gun 10 is put aside, the mixed material within mixer nozzle 20 quickly hardens and bonds to the interior of mixer nozzle 20. As a result, mixer nozzle 20 becomes unusable and must be discarded and replaced by a new mixer nozzle when the use of applicator gun 10 is resumed. It will be recognized that the need to discard mixer nozzles following each use represents an undesired cost to the user.

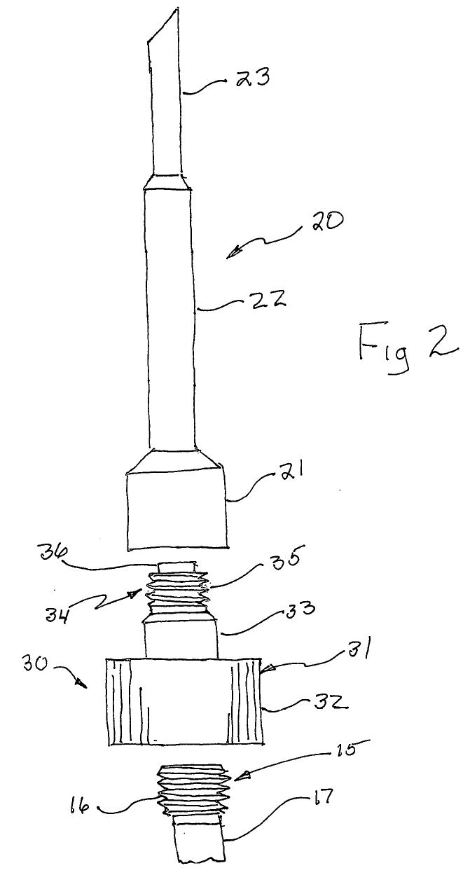

FIG. 2 sets forth an assembly view of conventional mixer nozzle 20 shown in FIG. 1 together with the present invention flush adapter generally referenced by 30. FIG. 2 also shows the end of a conventional hose 17 supporting a conventional hose fitting 13 having a plurality of external threads 16 in further accordance with conventional fabrication. As described above, mixer nozzle 20 includes a material coupler 21 together with a mixer chamber 22 and a discharge tip 23. As is better seen in FIG. 3, material coupler 21 of mixer nozzle 20 defines a threaded coupler having a plurality of internal threads 26.

A flush adapter 30, constructed in accordance with the present invention, includes a generally cylindrical adapter body 31 having a hose coupler 32 also defining a generally cylindrical outer surface. The outer surface of hose coupler 32 preferably supports surface features such as a straight knurl, or the like, the function of which is to facilitate gripping adapter body 31 to secure hose coupler 32 to hose fitting 15. Flush adapter 30 further includes a generally cylindrical extension 33 supporting a threaded coupler 34 which, in turn, includes external threads 35. A cylindrical end 36 is supported above external threads 35.

In operation, assuming mixer nozzle 20 has been employed in the above described operation and is now filled with a mixture of the two-component adhesive material, flush adapter 30 is secured to hose fitting 15 by the threaded attachment (seen in FIG. 3) within hose coupler 32. Thereafter, mixer nozzle 20 is assembled to flush adapter 30 by the threaded cooperation between internal threads 26 (shown in FIG. 3) and external threads 35 of threaded coupler 34. In this manner, flush adapter 30 and mixer nozzle 20 are coupled to hose 17 which, in turn, by means not shown will be understood to be coupled to a conventional source of water under pressure. The present invention nozzle cleaning method is then initiated by activating the source of water under pressure (not shown) to which hose 17 is coupled. The water under pressure passes through flush adapter 30 and is forced into mixer nozzle 20. It is a requirement of the inventive system that the flushing of mixer nozzle 20 be initiated before the material mixture therein begins hardening. The water applied to mixer nozzle 20 forces the material within mixer nozzle 20 outwardly through mixer chamber 22 and discharge tip 23. This movement of flushing water forces the adhesive mixture outwardly from mixer nozzle 20 and cleans the interior of mixer nozzle 20. Once the water flushing process has been completed and the two-component material has been removed, mixer nozzle 20 is again available for use. In accordance with an important aspect of the present invention, the water flushing of mixer nozzle 20 must be carried forward before the two-component mixture within mixer nozzle 20 has cured and hardened. In this manner, the expense of discarding and replacing the mixer nozzle following each use is avoided. This provides an improved efficiency and economy of operation.

FIG. 3 sets forth a section view of flush adapter 30 utilized in accordance with the present invention for cleaning and restoring mixer nozzles following their use in the above described application of two-component materials. More specifically, FIG. 3 sets forth a section view of flush adapter 30. As described above, flush adapter 30 includes a cylindrical hose coupler 32 which in turn defines a plurality of internal threads 36. As is also described above, flush adapter 30 further defines a cylindrical extension 33 which in turn supports a threaded coupler 34. Threaded coupler 34 supports a plurality of external threads 35 together with a cylindrical end 36. A conventional water hose 17 having a hose fitting 15 which includes external threads 16 is received within hose coupler 32 by engagement between external threads 16 of hose fitting 15 arid internal threads 36 of hose coupler 32. A seal washer 37 is positioned upon the upper end of hose fitting 15 to provide a watertight seal between hose fitting 15 and hose coupler 32.

In accordance with the present invention mixer nozzle 20 is secured to threaded coupler 34 of flush adapter 30 by the engagement of external threads 35 of flush adapter 30 and internal threads 26 within material coupler 21 of mixer nozzle 20. As is described above mixer nozzle 20 is preferably formed of a single one piece molded unit fabricated of a suitable plastic material or the like. As is also set forth above mixer nozzle 20 includes a material coupler 21 defining internal threads 26 joined to an elongated mixer chamber 22. Mixer chamber 22 defines a mixer passage 24 there through and is joined to a discharge tip 23. In further accordance with the utilization of the present invention apparatus and method, it is assumed that mixer nozzle 20 is filled with a two-component material such as an epoxy resin and hardener following use in the above described application. In further accordance with the present invention method flush adapter 30 is threaded upon hose fitting 15 captivating seal washer 37 while mixer nozzle 20 is threaded upon threaded coupler 34 of flush adapter 30. When water under pressure is applied to hose 17 the water under pressure is forced upwardly through passage 38 of flush adapter 30 and thereafter continues through mixer chamber 22. The flow of water within mixer chamber 22 forces two-component material off of the surfaces of mixer 25 flushing it outwardly from mixer chamber 22 through discharge tip 23. Once the complete flushing of two-component material has cleared mixer nozzle 20, the flow of water under pressure is terminated and mixer nozzle 20 is removed from flush adapter 30. The cleaned and flushed mixer nozzle is then available for reuse.

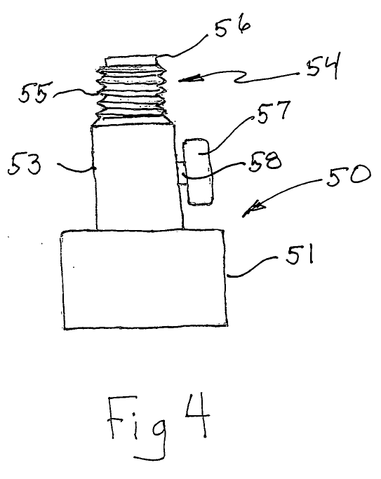

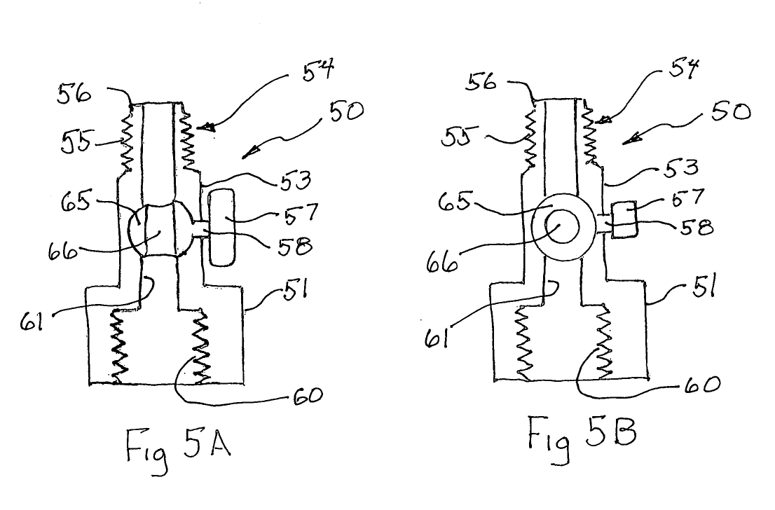

FIG. 4 sets forth a side elevation view of an alternate embodiment of the present invention flush adapter generally referenced by 50. Flush adapter 50 is substantially the same as flush adapter 30 set forth above with the primary difference being found in the lengthening of cylindrical extension 33 (seen in FIG. 3) to accommodate a ball valve utilized in controlling the flow of water through flush adapter 50. More specifically, flush adapter 50 includes a hose coupler 51 which, as it is better seen in FIGS. 5A and 5B, defines a plurality of the internal threads 60. Flush adapter 50 further includes a cylindrical extension 53 joined to a threaded coupler 54. Threaded coupler 54, in turn, supports an extending cylindrical and 56. In further accordance with the alternate embodiment of FIG. 4, a shaft 58 passes through cylindrical extension 53 and supports a knob 57. With temporary reference to FIG. 5A, it will be seen that shaft 58 is joined to a ball valve 65. Flush adapter 50 is utilized in the identical manner in which flush adapter 30 set forth above in FIGS. 2 and 3 is used in that hose coupler 51 is to secured to hose fitting 15 (seen in FIG. 3) and threaded coupler 54 is threadably secured to material coupler 21 of mixer nozzle 20 (seen in FIG. 3). Accordingly, the above described use of flush adapter 30 in cleaning mixer nozzle 20 will be understood to apply with equal force and effect to the corresponding use of lush adapter 50.

FIG. 5A sets forth a section view of flush adapter 50 in the open valve configuration. As described above flush adapter 50 includes arose coupler 51 supporting a cylindrical extension 53. As is also described above, flush adapter 50 includes a threaded coupler 54 having a plurality of external threads 55 and a cylindrical and 56. A knob 57 is supported upon a shaft 58. Flush adapter 50 further includes a passage 61 extending from hose coupler 51 through cylindrical extension 53 and threaded coupler 54. A ball valve 65 defining a valve passage 66 is supported within cylindrical extension 53 and is joined to shaft 58. FIG. 5A depicts the open valve configuration of flush adapter 50. Accordingly, knob 57 is rotated to rotate valve ball 65 and provide alignment of valve passage 66 with passage 61 of flush adapter 50. In this configuration, the resulting ball valve is in an open condition and water freely flows through passage 61. This corresponds to the above described material flushing process employed when a mixer nozzles such as mixer nozzle 20 (seen in FIG. 3) is threaded upon threaded coupler 54.

FIG. 5B sets forth a section view of flush adapter 50 in the closed valve configuration. As described above, flush adapter 50 includes a hose coupler 51 porting a cylindrical extension 53. As is also described above flush adapter 50 includes a threaded coupler 54 having a plurality of external threads 55 and a cylindrical and 56. A knob 57 is supported upon a shaft 58. Flush adapter 50 further includes a passage 61 extending from hose coupler 51 through cylindrical extension 53 and threaded coupler 54. A ball valve 65 defining a valve passage 66 is supported with and cylindrical extension 53 and is joined to shaft 58. FIG. 5B depicts the closed valve configuration of flush adapter 50. Accordingly, knob 57 is rotated to rotate valve ball 65 such that valve passage 66 is out of alignment with passage 61 of flush adapter 50. In this configuration, the resulting ball valve is in a closed condition and water cannot flow through passage 61.

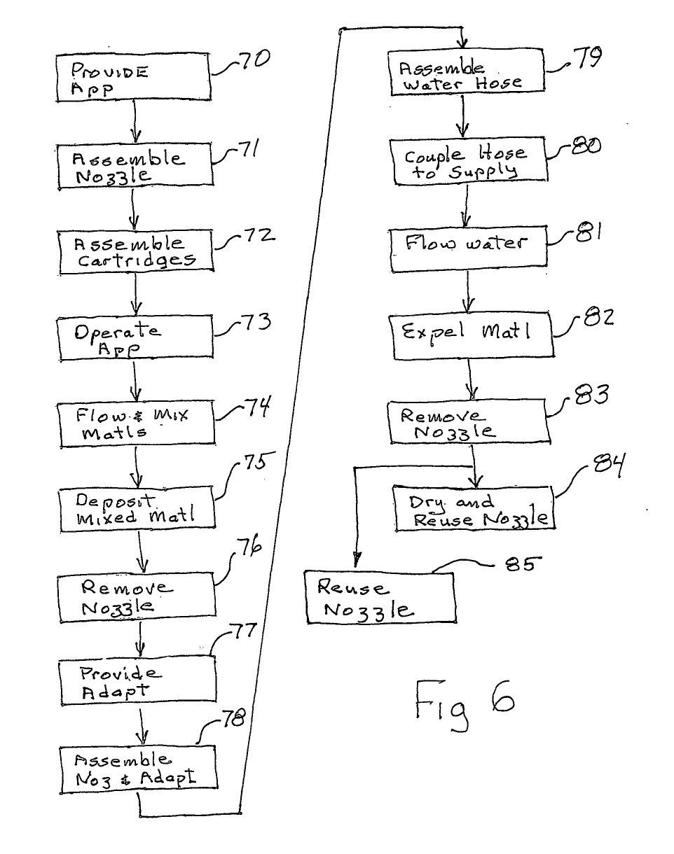

FIG. 6 sets forth a flow diagram for the present invention method for flushing and renewal of mixer nozzles operated in combination with-component adhesive materials or the like. The method begins at step 70 in which a two-component applicator is provided. Thereafter, a mixer nozzle is assembled to the applicator at a step 71. Following step 71 a pair of material cartridges are loaded into the applicator. At step 73 the two-component material applicator is utilized. At step 74 the two-component material is caused to flow through the applicator and mixed with than the mixer nozzle. At step 75 the flowing mixed two-component material is deposited upon the work piece at step 76 the mixer nozzle is removed from the applicator. At step 77 a flush adapter constructed in accordance with the present invention is provided after which at step 78 the mixer nozzle is coupled to the flush adapter. At step 79 the flush adapter is coupled to a water hose and at step 80 the water hose is coupled to a supply of water under pressure. At step 81 the water under pressure is allowed to flow through the flush adapter and the mixer nozzle resulting in the expulsion of the two-component material from the mixer nozzle at step 82. At step 83 the cleaned nozzle is removed from the flush adapter. Following step 83, the method may alternatively reuse the nozzle directly while still wet by going to step 85 for nozzle reuse. This direct reuse while still wet from the flush at steps 81 and 82 is possible because the epoxy material is not water soluble and therefore remaining water is forced out once the nozzle is reattached and material flows through the nozzle. If it is preferred that the nozzle be dried before reuse, the method moves from step 83 to step 84 and the clean nozzle is dried and reused.

What has been shown is a novel epoxy applicator nozzle flush adapter and method by which repeated use of mixer nozzles is facilitated. The previous need to discard mixer nozzles following each interval of use and the corresponding costs associated with the discarding of such used mixer nozzles is avoided. The present invention apparatus and method is readily utilize with conventional applicator guns and simply requires a conventional source of water under pressure.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in combination with a mixer nozzle having a material coupler defining a plurality of internal threads, an elongated mixer chamber supporting an elongated mixer, a discharge tip extending from the mixer chamber and a mixer passage extending through the material coupler, mixer chamber and discharge tip, a nozzle flush adapter comprising:
a nozzle flush adapter body defining a hose coupler having a plurality of internal threads supported therein, a cylindrical extension extending from said hose coupler, a threaded coupler extending from said cylindrical extension and defining a plurality of external threads and a cylindrical end extending from said cylindrical extension; and
a nozzle flush adapter passage extending through said hose coupler, said cylindrical extension, said threaded coupler and said cylindrical extension,
whereby said nozzle flush adapter is assembled to the end of a conventional water hose by threading the end thereof into said plurality of internal threads and thereafter joining a mixer nozzle to said nozzle flush adapter by threading said external threads into the plurality of internal threads of the material coupler of the mixer nozzle after which a flow of water from the hose flows through said nozzle flush adapter passage and the mixer nozzle to flush material from the mixer nozzle and prepare it for reuse.

2. The nozzle flush adapter set forth in claim 1 further including a ball valve supported within said adapter body operative upon said nozzle flush adapter passage to operatively close or open said nozzle flush adapter passage.

3. For use in combination:
a mixer nozzle having a material coupler defining a plurality of internal threads, an elongated mixer chamber supporting an elongated mixer, a discharge tip extending from said mixer chamber and a mixer passage extending through said material coupler, mixer chamber and discharge tip;
a nozzle flush adapter body defining a hose coupler having a plurality of internal threads supported therein, a cylindrical extension extending from said hose coupler, a threaded coupler extending from said cylindrical extension and defining a plurality of external threads and a cylindrical end extending from said cylindrical extension; and
a nozzle flush adapter passage extending through said hose coupler, said cylindrical extension, said threaded coupler and said cylindrical extension,
whereby said nozzle flush adapter is assembled to the end of a conventional water hose by threading the end thereof into said plurality of internal threads and thereafter joining said mixer nozzle to said nozzle flush adapter by threading said external threads into said plurality of internal threads of said material coupler of said mixer nozzle after which a flow of water from the hose flows through said nozzle flush adapter passage and said mixer nozzle to flush material from said mixer nozzle and prepare it for reuse.

4. The nozzle flush adapter set forth in claim 3 further including a hall valve supported within said adapter body operative upon said nozzle flush adapter passage to operatively close or open said nozzle flush adapter passage.

5. A method for using and reusing a mixer nozzle utilized in the mixing and application of a two component compound comprising the steps of:
providing a mixer nozzle, a pair of material cartridges, and applicator;
operating said applicator to mix material flowing from said pair of cartridges and to dispense a flow of mixed material;
depositing said mixed material upon a work piece;
removing said mixer nozzle from said applicator;
providing a nozzle flush adapter having a nozzle flush adapter body defining a hose coupler having a plurality of internal threads supported therein, a cylindrical extension extending from said hose coupler, a threaded coupler extending from said cylindrical extension and defining a plurality of external threads and a cylindrical end extending from said cylindrical extension;
assembling said mixer nozzle to said nozzle flush adapter;
assembling said nozzle flush adapter to a water hose, said water hose coupled to a water supply;
flowing water from said hose through said nozzle flush adapter and said mixer nozzle to flush and expel remaining two-part mixed compound from said mixer nozzle;
removing said mixer nozzle from said nozzle flush adapter; and
reusing said mixer nozzle.

6. The method set forth in claim 5 further including the step of drying said mixer nozzle following said step of flowing water from said hose through said nozzle flush adapter.
